(19) United States
(12) Patent Application Publication
(10) Pub. No.: US 2023/0022053 A1
(43) Pub. Date: Jan. 26, 2023

(54) AUCTION RESULT ADJUSTMENT WITH THRESHOLD-BASED STAKEHOLDER SIMULATIONS

(71) Applicant: NewPartner Energy Technologies LLC, Larchmont, NY (US)

(72) Inventor: Noam Yaffe, Scarsdale, NY (US)

(21) Appl. No.: 17/869,170

(22) Filed: Jul. 20, 2022

Related U.S. Application Data
(60) Provisional application No. 63/224,007, filed on Jul. 21, 2021.

(51) Int. Cl. G06Q 30/08

(52) U.S. Cl. CPC G06Q 30/08

(57) ABSTRACT

A reverse auction system includes a memory that stores instructions, and a processor that executes the instructions. When executed by the processor, the instructions cause the reverse auction system to: receive terms for initiating an auction; receive at least one proposal for the auction; simulate, for each proposal, a range of potential scenarios of attempts to fulfill the proposal; categorize, based on simulating the range of potential scenarios for each proposal, each proposal that is likely to be unfulfillable; identify each proposal categorized as likely to be unfulfillable; and determine one or more viable proposals as possible auction winners.

### CROSS-REFERENCE TO RELATED APPLICATION

This U.S. non-provisional patent application claims the benefit of priority under 35 U.S.C. § 119(e) to U.S. Provisional Patent Application No. 63/224,007, filed on Jul. 21, 2021 in the United States Patent and Trademark Office, the disclosure of which is incorporated herein in its entirety by reference.

### BACKGROUND

A simple conventional price auction may involve a seller placing something for sale and then accepting proposals from prospective buyers with incrementally higher prices until no more bids are made. In a reverse price auction, the roles of buyer and seller are reversed. A simple example of a conventional reverse price auction involves a buyer requesting to buy something and then accepting proposals that incrementally lower prices until no more offers are made. Reverse auctions and auctions are not, however, limited to reverse price auctions and price auctions, and an auction manager may facilitate a reverse auction or auction by receiving proposals (either offers or bids) from proposers and then sorting the proposals based on price and other standard economic attributes to determine an auction winner.

Some modern reverse auctions and auctions involve complex terms, and an example of this is reverse auctions and auctions for renewable energy. Renewable energy power purchase agreements and other power hedges may be referred to as renewable energy contracts. A reverse auction to buy output from a renewable energy plant to be developed may involve many different terms beyond price, and the complexity of many different terms now results in some proposals being made that are not feasible. If the unfeasible proposals are declared winners without being recognized as unfeasible until after the reverse auctions or auctions conclude and renewable energy contracts are awarded/finalized, the reverse auctions and auctions may be rendered moot and both the proposers and the buyers or sellers may suffer economic losses, power plant development timeline delays, and even contract renegotiations. Ultimately, unnecessary amounts of CO2 and other chemicals are emitted into the atmosphere due to these extended negotiations and delays.

Problems with unfeasible proposals being made for renewable energy contracts are, at least in part, due to renewable energy contracts being individually customized and not interchangeable. Proposals for renewable energy contracts are therefore difficult to compare, and reverse auctions for renewable energy plants may fail to incorporate terms that would cover material aspects of proposal viability, including whether proposers will be able to meet proposal obligations. While buyers (e.g., institutional energy consumers, utilities) continue to use conventional reverse price auctions to select proposals with low power prices, ‘winning’ renewable energy project developers end up with renewable energy contracts that have low strike prices and high contractual risks. This price-to-risk mismatch is often unattractive to lenders and long-term equity investors. As a result, it is common for renewable energy contracts to take many months and sometimes a year to negotiate. Developers may then struggle to find proper project financing, and too often delay projects or renegotiate renewable energy contracts with their customers. In fact, some sellers now refuse to respond to over-subscribed ‘race-to-the-bottom’ reverse auctions for renewable energy plants.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1A illustrates a visualization of theoretical results versus actual/predictable results in a reverse auction, in accordance with an aspect of the present disclosure.

FIG. 1B illustrates a visualization of theoretical results versus actual/predictable results in an auction, in accordance with an aspect of the present disclosure.

FIG. 2A illustrates a predictive network arrangement for auction result adjustment with threshold-based stakeholder simulations, in accordance with a representative embodiment of the present disclosure.

FIG. 2B illustrates another predictive network arrangement for auction result adjustment with threshold-based stakeholder simulations, in accordance with a representative embodiment of the present disclosure.

FIG. 3A illustrates a method for auction result adjustment with threshold-based stakeholder simulations, in accordance with a representative embodiment of the present disclosure.

FIG. 3B illustrates a method for simulating in auction result adjustment with threshold-based stakeholder simulations, in accordance with a representative embodiment of the present disclosure.

FIG. 4A illustrates another visualization of theoretical results versus actual/predictable results in a reverse auction, in accordance with a representative embodiment of the present disclosure.

FIG. 5A illustrates a computer system for auction result adjustment with threshold-based stakeholder simulations, in accordance with a representative embodiment of the present disclosure.

FIG. 5B illustrates a controller for auction result adjustment with threshold-based stakeholder simulations, in accordance with another representative embodiment of the present disclosure.

### DETAILED DESCRIPTION

In the following detailed description, for the purposes of explanation and not limitation, representative embodiments disclosing specific details are set forth in order to provide a thorough understanding of an embodiment according to the present teachings. Descriptions of known systems, devices, materials, methods of operation and methods of manufacture may be omitted so as to avoid obscuring the description of the representative embodiments. Nonetheless, systems, devices, materials, and methods that are within the purview of one of ordinary skill in the art are within the scope of the present teachings and may be used in accordance with the representative embodiments. It is to be understood that the terminology used herein is for purposes of describing particular embodiments only and is not intended to be limiting. The defined terms are in addition to the technical and scientific meanings of the defined terms as commonly understood and accepted in the technical field of the present teachings.

It will be understood that, although the terms first, second, third etc. may be used herein to describe various elements or components, these elements or components should not be limited by these terms. These terms are only used to distinguish one element or component from another element or component. Thus, a first element or component discussed below could be termed a second element or component without departing from the teachings of the inventive concept.

The terminology used herein is for purposes of describing particular embodiments only and is not intended to be limiting. As used in the specification and appended claims, the singular forms of terms ‘a’, ‘an’ and ‘the’ are intended to include both singular and plural forms, unless the context clearly dictates otherwise. Additionally, the terms “comprises”, and/or “comprising,” and/or similar terms when used in this specification, specify the presence of stated features, elements, and/or components, but do not preclude the presence or addition of one or more other features, elements, components, and/or groups thereof. As used herein, the term “and/or” includes any and all combinations of one or more of the associated listed items.

Unless otherwise noted, when an element or component is said to be “connected to”, “coupled to”, or “adjacent to” another element or component, it will be understood that the element or component can be directly connected or coupled to the other element or component, or intervening elements or components may be present. That is, these and similar terms encompass cases where one or more intermediate elements or components may be employed to connect two elements or components.

The present disclosure, through one or more of its various aspects, embodiments and/or specific features or sub-components, is thus intended to bring out one or more of the advantages as specifically noted below. For purposes of explanation and not limitation, example embodiments disclosing specific details are set forth in order to provide a thorough understanding of an embodiment according to the present teachings. However, other embodiments consistent with the present disclosure that depart from specific details disclosed herein remain within the scope of the appended claims. Moreover, descriptions of well-known apparatuses and methods may be omitted so as to not obscure the description of the example embodiments. Such methods and apparatuses are within the scope of the present disclosure.

As described herein, replacing conventional reverse price auctions for output from renewable energy plants with reverse risk and value weighted auctions conducted for output from renewable energy plants may allow for significantly de-risking contract structures and negotiation, and acceleration of development timelines for underlying development projects, resulting in significant abatements of CO2 and other types of chemical emissions.

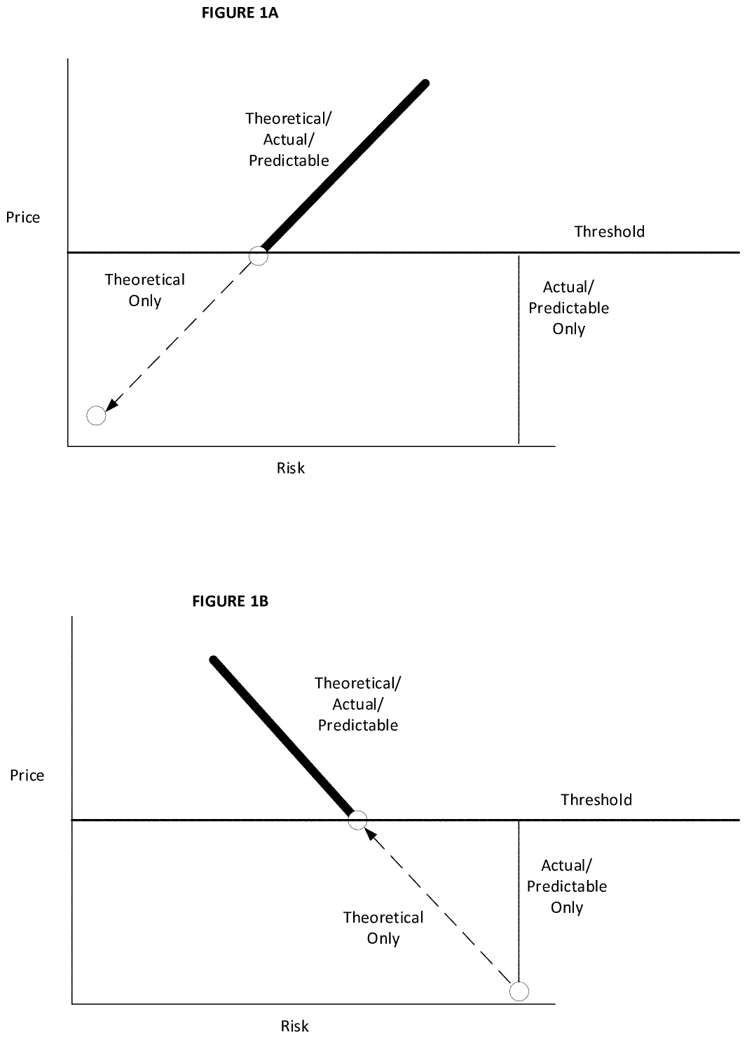

FIG. 1A illustrates a visualization of theoretical results versus actual/predictable results in a reverse auction, in accordance with an aspect of the present disclosure.

In FIG. 1A, a theoretical chart pattern of price versus risk (to the buyer) for a reverse auction descends from the upper right to the origin. However, for some complex reverse auctions, the part of the chart pattern closest to the origin is only theoretical, as there may be a price below which proposals to sell something to the buyer are untenable for any number of reasons. In a simple example for a developer of a renewable energy plant, the developer may propose to develop a renewable energy plant and sell energy from the plant at a low price which will not cover the cost of loans the owner (whether the developer or a subsequent owner) will incur to develop or operate the plant. The developer may propose to sell energy at the low price in good faith and not realize for six or nine months that no lender will provide a loan for the renewable energy plant with the prospect of the output of the plant being sold for the low price. When this happens, the reverse auction may have to be held again, and all parties suffer.

In FIG. 1A, the vertical line marked “actual/predictable” only shows prices at which proposals are riskier in practice than in theory. The horizontal line marks a threshold that delineates where price is too low to justify corresponding offers, though the concept of price is entirely too simplistic in most cases given the complexity of terms submitted in offers in the types of reverse auctions for which the technology described herein will mostly be applied. The vertical line reflects a market failure that results at least partly from not having information of the risks associated with proposals at the corresponding prices. The teachings herein demonstrate mechanisms for identifying the locations of the vertical line and the threshold.

In FIG. 1A, the vertical axis is marked “price”. However, as explained herein, price is only an example of a term or terms in a proposal. The terms in a proposal may include many types of information besides price, and the vertical axis may therefore be appropriately labelled “terms”, or in the specific example of a reverse auction, “offer terms”. The complex reverse auction(s) described herein may be conducted for renewable energy plant development. As will be clear from the descriptions below, offers in a complex reverse auction may involve many terms, and individual terms may be quantified and/or digitized as one of binary sets of values or one of ranges of values, and the individual terms or combinations of individual terms may be subject to tests that will help determine if the renewable energy contracts resulting from the offers are unfulfillable or likely unfulfillable.

FIG. 1B illustrates a visualization of theoretical results versus actual/predictable results in an auction, in accordance with an aspect of the present disclosure.

In FIG. 1B, a theoretical chart pattern of price versus risk (to the seller) for an auction ascends from the lower right to the upper left. However for some complex auctions, the part of the chart pattern closest to the bottom is only theoretical, as there may be a price below which proposals to buy something are untenable for any number of reasons. In a simple example for a developer of a renewable energy plant, a developer may propose to develop a renewable energy plant and sell energy from the plant to the highest bidder. In a typical auction, bids start low and ascend higher as shown, which reduces risk for the seller. However, as shown in FIG. 1B, at the lowest prices the actual risk is the highest possible to the seller since it will not be feasible for the developer to develop the plant and profitably sell energy at the low prices, so no bids from potential buyers should be accepted at these low prices. The developer may again agree to sell energy at the low price in good faith and not realize for six or nine months that no lender will provide a loan for the renewable energy plant with the prospect of the output of the plant being sold for the low price. When this happens, the auction may have to be held again, and all parties suffer.

In FIG. 1B, the horizontal line marks a threshold that delineates where price is too low to justify development of the underlying development project and sale of the output from the resultant renewable energy plant. In the case of an auction, the ability to define the threshold will allow the developer in an auction to appropriately set a minimum bid price, though again the concept of price will typically be too simplistic given the complexity of terms in complex areas such as renewable energy contracts. The vertical line again reflects a market failure that results at least partly from not having information of the risks associated with proposals at the corresponding prices. The teachings herein demonstrate mechanisms for identifying the locations of the vertical line and the threshold.

In FIG. 1B, the vertical axis is again marked “price”. However, as explained herein, price is only an example of terms in a proposal. The terms in a proposal may include many types of information besides price, and the vertical axis may therefore be appropriately labelled “terms”, or in the specific example of an auction, “bid terms”. As will be clear from the descriptions below, bids in a complex auction may involve many terms, and individual terms may be quantified and/or digitized as one of binary sets of values or one of ranges of values, and the individual terms or combinations of individual terms may be subject to tests that will help determine if the renewable energy contracts resultant from the bids are unfulfillable or likely unfulfillable.

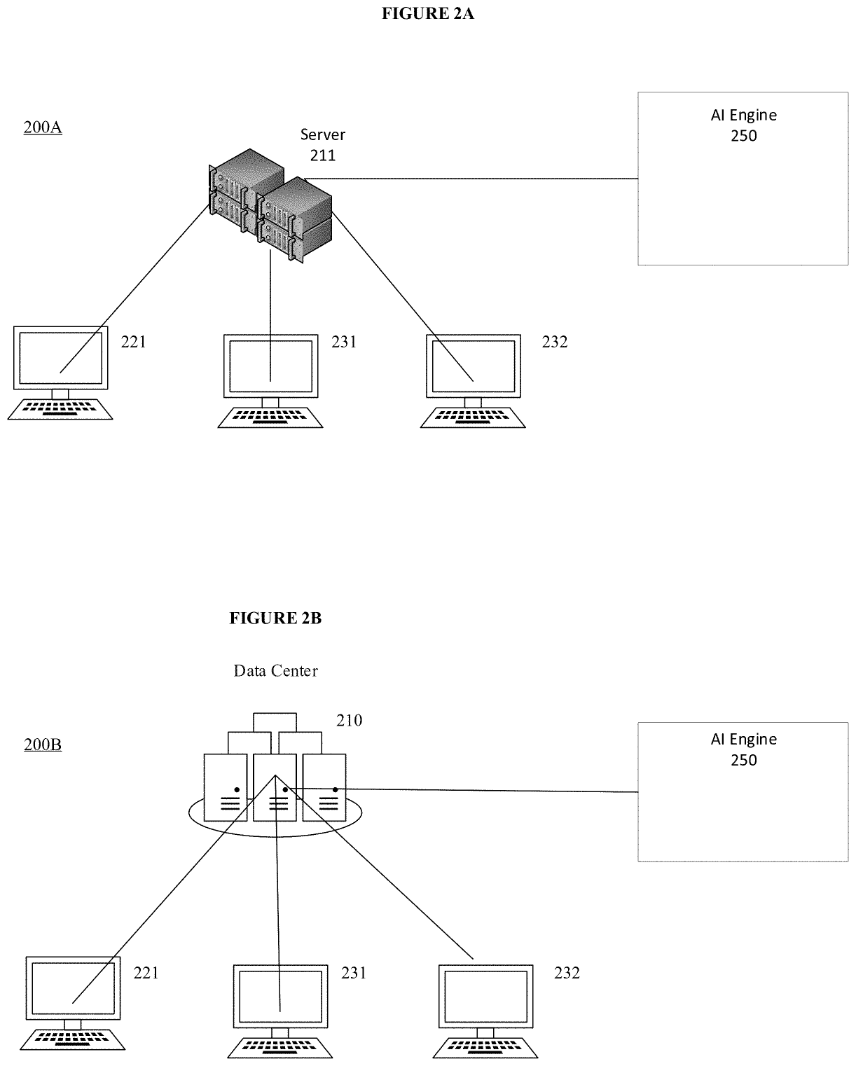

FIG. 2A illustrates a predictive network arrangement 200a for auction result adjustment with threshold-based stakeholder simulations, in accordance with a representative embodiment.

In FIG. 2A, the predictive network arrangement 200a includes a server 211, a first networked communications device 221, a second networked communications device 231 and a third networked communications device 232. The server 211 is connected to AI engine 250. The server 211, first networked communications device 221, second networked communications device 231, third networked communications device 232 and the AI engine 250 communicate over one or more communications networks such as the internet (not shown). The AI engine 250 applies artificial intelligence to dynamically predict thresholds to delineate proposals which should not be accepted as described herein.

In the embodiment of FIG. 2A the server 211 may implement thresholding on behalf of an entity that coordinates the reverse auction or auction as a service. For example, the server 211 may be directly or indirectly controlled by an entity that provides the service.

The first networked communications device 221, the second networked communications device 231 and the third networked communications device 232 are all networkable computing devices such as personal computers, laptop computers, smartphones, or tablet computers. Each of the first networked communications device 221, the second networked communications device 231 and the third networked communications device 232 includes or is provided along with a monitor or other type of electronic screen to display information. The networks that connect the first networked communications device 221, the second networked communications device 231 and the third networked communications device 232 may include the internet, but also may include private and dedicated proprietary communications networks and/or network connections.

In FIG. 2A, the server 211 hosts a software application on behalf of a service provider, and the server 211 may control or even directly implement most or all of the functionality of methods described herein. However, the first networked communications device 221, the second networked communications device 231 and the third networked communications device 232 may each also or alternatively be provided with applications installed thereon to implement one or more aspects of the methods described herein.

The AI engine 250 in FIG. 1A may apply trained artificial intelligence, possibly through a machine-learning framework, to determine thresholds to apply to proposals for reverse auctions and auctions. The trained artificial intelligence may be recursively updated based on each instantiation of successful and unsuccessful reverse auctions and auctions, including reverse auctions and auctions that are only shown to be unsuccessful long after they occur. Alternatively, the trained artificial intelligence may be updated periodically or otherwise based on batches of instantiations of successful and unsuccessful reverse auctions and auctions, such as reverse auctions and auctions that have occurred since the last update to the trained artificial intelligence.

The AI engine 250 may use multiple types of parameterized inputs to identify the thresholds. Thresholds reflecting two inputs may be thought of and visualizable as two-dimensional thresholds, thresholds reflecting three inputs may be thought of and visualizable as three-dimensional thresholds, and so on. The AI engine 250 may accept numerous types of data and identify the types of data most relevant to determining the threshold(s) for each reverse auction and auction. Types of data that are input but determined to be relatively irrelevant may be entirely or largely ignored in the thresholding described herein. Additionally, as described in more detail below, parameterization may reflect binary results such as yes or no, pass or fail, profitable or unprofitable and so on, or may reflect ranges of results such as from 1 to 100, 0.01 to 0.99, and so on. Binary determinations for terms may be important as pass/fail mechanisms, particularly when a “failure” may itself render a proposal unfulfillable or likely to be unfulfillable.

FIG. 2B illustrates another predictive network arrangement 200a for auction result adjustment with threshold-based stakeholder simulations, in accordance with a representative embodiment.

In FIG. 2B, the network 200B includes a data center 210, the first networked communications device 221, the second networked communications device 231 and the third networked communications device 232. The data center 210 is connected to the AI engine 250. The data center 210, the first networked communications device 221, the second networked communications device 231, the third networked communications device 232 and the AI engine 250 communicate over one or more communications networks such as the interne (not shown). The AI engine 250 may again provide artificial intelligence to determine the threshold(s) to apply to proposals for reverse auctions and auctions as described herein.

In the embodiment of FIG. 2B the data center 210 may implement thresholding for proposals as a service on behalf of an entity that provides the reverse auctions and auctions. For example, the data center 210 may be representative of a cloud service that hosts and executes software applications as services for entities including the entity. The data center 210 may include multiple servers such as the server 211 from FIG. 2A. The multiple servers provided by a cloud service may variably implement thresholding as a service, such as an on-demand service. For example, one or more of the servers provided by a cloud service may be selectively controlled to dynamically implement the service based on availability on-demand or as a periodic (e.g., daily) service. In other embodiments, thresholding may be provided under a software license as a complete software package sold over the internet or on a computer-readable medium.

In FIG. 2A and in FIG. 2B, the second networked communications device 231 and the third networked communications device 232 are shown as devices used by proposers representing either asks or bids. However, fewer than two or more than two proposers may respond and make proposals in a reverse auction or auction in embodiments described herein. Insofar as proposers may be competing with one another, a server-based auction system and/or reverse auction system for thresholding proposals may be implemented by the server 211 and/or the data center 210 and may identify the threshold(s) for proposals in the auctions or reverse auctions. The server-based auction system and/or reverse auction system implemented by the server 211 and/or the data center 210 may analyze the full set of proposals including numerous types of inputs, and identify the subset of proposals which are not feasible.

In the embodiments of FIG. 2A and FIG. 2B, thresholding may be implemented using software executed by the server 211 and/or the data center 210 for renewable energy buyers such as corporations and utilities, renewable energy sellers such as developers and long-term asset owners, and renewable energy investors such as credit support or collateral providers, tax equity investors, cash equity investors, and lenders, to manage the origination and renewable energy deal structuring processes. The server 211 and/or the data center 210 are programmed to efficiently identify thresholds for proposals that are implementable for developing renewable energy. The server 211 and the data center 210 may be accompanied with one or more neutral (unbiased) database(s) of information and analytics.

In some embodiments, the server 211 and/or the data center 210 may also provide other services for reverse auctions and auctions. For example, the server 211 and/or the data center 210 may provide services for guided position matching between parties in reverse auctions and auctions, as described in U.S. patent application Ser. No. 17/104,014, filed on Nov. 25, 2020 and issued as U.S. Pat. No. 11,360,449 on Jun. 14, 2022, the contents of which are incorporated herein in the entirety. For example, when templates are used to accept terms of proposals in a reverse auction, each selection of the terms from a template may be assigned a risk-weighting factor that is usable to help determine the overall risk profile of the proposal if the proposal were to be accepted. Each proposal may be generated and evaluated on a risk-adjusted basis. Thresholding described herein may use risk-adjusted terms from template-based proposals as inputs to the AI engine 250.

Using the server 211 and the data center 210, auction managers are provided with simulation technology and methodologies that are used during proposal creation and/or after proposal submission to evaluate and judge proposers and their proposals in order to determine proposal viability or the likelihood that a proposer will be able to fulfill future proposal obligations. As an example, if a seller submits a proposal to a buyer with an aggressively low power price on behalf of a solar project under development, the simulations may allow the auction manager to determine whether the development project owner will be able to raise enough money to construct a power plant facility and then operate it safely so as to meet the proposal obligation of constructing and delivering a power plant.

Simulations may be partly or fully binary in nature or, alternatively may involve minimum thresholds. If minimum requirements are not met while simulating various outcomes, the proposal in question may be categorized as ‘likely unfulfillable.’ If the minimum requirements are met, the proposal may be categorized as ‘likely fulfillable.’ If there are multiple proposals, some may be ‘likely unfulfillable’, some may be “likely fulfillable, and others may be categorized differently, showing a spectrum of three or more proposal viability levels. The various simulation outputs may yield a viability score that is applied to proposals not categorized as ‘likely unfulfillable.’ In this way, an auction manager may (1) understand which proposals can be discarded, (2) which proposals should continue to be evaluated, and (3) the viability level of each proposal to be evaluated.

In addition to proposal viability, simulations may simulate standard economic scenarios related to normal reverse auctions and auctions for proposals that are not categorized as ‘likely unfulfillable.’ The auction manager may then combine the proposal viability levels with standard proposal economic scenarios to identify one or more optimal proposal(s) or auction winner(s) that are most suitable to the auction initiator.

In addition to proposal categorization and identifying an auction winner, proposals may be ranked against each other based on the results of various simulations, including binary simulation outputs, threshold-based simulation outputs, or range simulation outputs. Ranking may be implemented by the server 211 in FIG. 2A or the data center 210 in FIG. 2B.

Ranking may be implemented in a variety of ways. For instance, ranking may involve a single grouping of all proposals and based on a single simulation. Alternatively, proposals may be placed in different categories, so that a bin for each category may include zero, one or more proposals when applicable. Proposals placed in a top category may be subject to a simulation so that each proposal may be ranked. However, proposals in multiple categories may be ranked within the bin for each category, and one or more categories may be subject to more than one simulation. When ranks vary based on small changes in simulations, the top-ranked proposal(s) from multiple simulations may be provided to a power source developer or may be subject to a tie-breaker simulation.

In practice, some proposals may be categorized together as ‘likely fulfillable,’ but with different levels of confidence in the calculations or different levels of overall risk or value (to either buyer or seller). For example, two proposals received in an auction may have the same favorable pricing, but one proposal may include less credit support than the other. Practically, given that credit support is a key risk attribute in renewable energy contracts, the auction manager would likely prefer the proposal with more credit support. As such, the evaluation technology may rank proposals relative to other proposals received in the auction, and based on one simulation or more than one simulation. The auction manager may then be prompted with a list of proposals that are ranked, such as with #1 being the top recommended proposal, #2 being the 2^{nd} highest recommended proposal, and so on. The auction manager may also be prompted with a list of proposals that are ranked for each of multiple simulations, when the ranks vary between simulations. The server 211 or the data center 210 may rank each proposal in a category, such as proposals categorized as likely to be fulfillable,

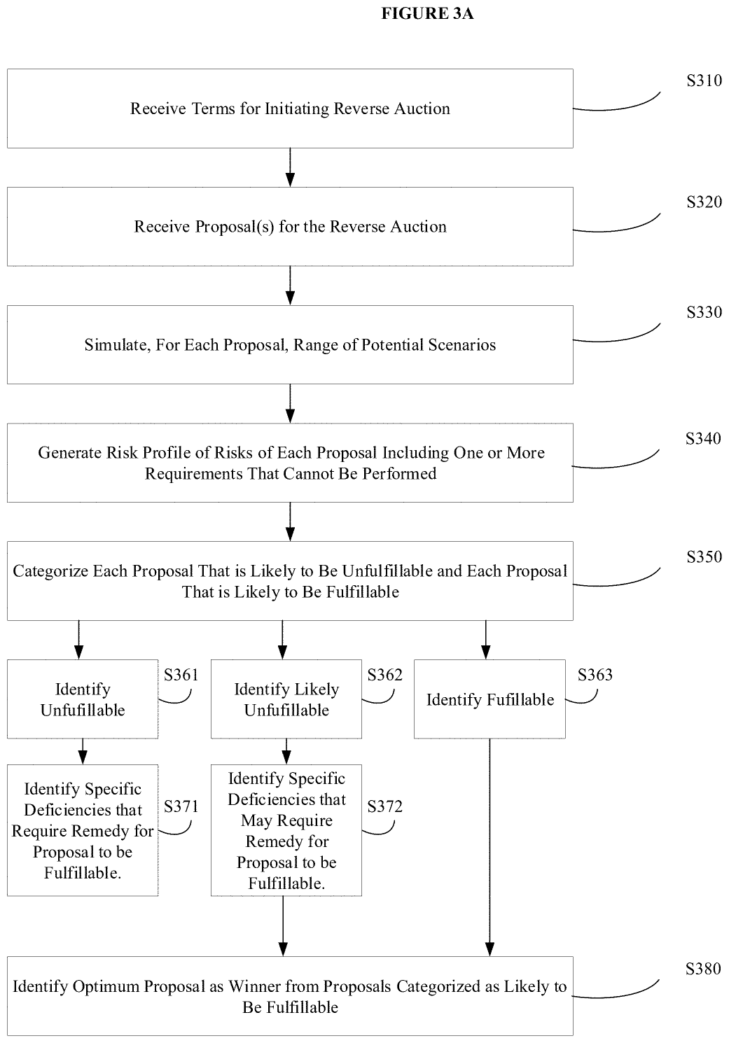

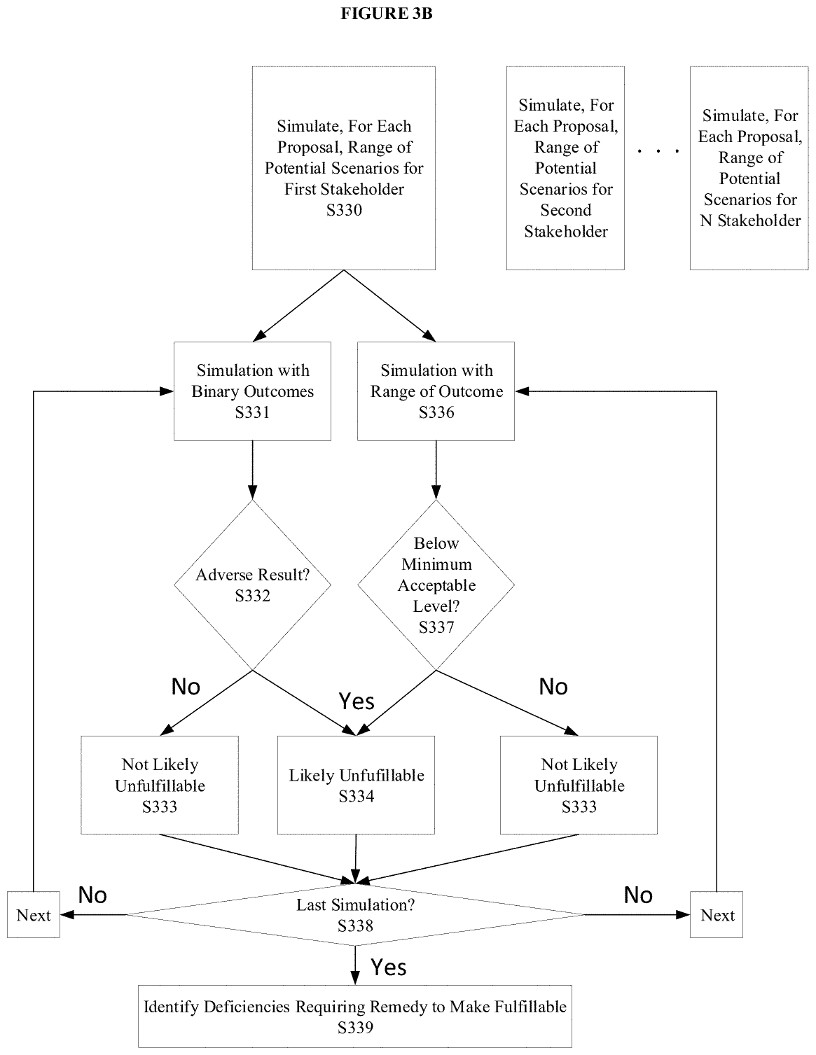

FIG. 3A illustrates a thresholding auction proposal process, in accordance with a representative embodiment. The method of FIG. 3A may be performed by a single apparatus, a single system, by or on behalf of a single entity, or by distributed apparatuses, distributed systems, or by or on behalf of multiple entities.

At S310 of FIG. 3A, terms for initiating a reverse auction are received. The terms for the reverse auction may be received at the server 211 in FIG. 2A or the data center 210 in FIG. 2B. The terms are received from the auction initiator, and may be sent using an application or website provided by the entity that implements the thresholding auction proposal process. The terms may be selected from a template provided via the application or website, and then received at the server 211 or the data center 210.

At S320, proposals for the reverse auction are received. The proposals may be received at the server 211 in FIG. 2A or the data center 210 in FIG. 2B, and may be received electronically from proposers at networked communications devices such as the second networked communications device 231 and the third networked communications device 232 representing asks since the example of FIG. 3A is for a reverse auction. In a regular auction, the proposals represent bids.

Proposal inputs for proposals at S320 may include project details/information, project certifications, proposal details, proposer details and information, and other terms and details for an underlying renewable energy contract that would result from agreement. A variety of examples of such proposal inputs for a proposal are explained next.

Proposal inputs:

a. Project details/information
i. AC/DC loading Ratio (if applicable)—for example, the amount of DC ‘overbuild,’ measured in as a multiple (e.g., 1.3×), on a solar power plant to ensure enough or optimal AC generation at the point of interconnection to the grid.
ii. Annual Land Cost (Lease)—for example, the cost in dollars per year to lease land to operate a renewable energy power plant.
iii. Annual Land Cost Escalator—for example, the percentage annual increase in a land lease contract to maintain to rights to operate a renewable energy facility.
iv. Annual OPEX—for example, the total cost in dollars to cover operating expenses related to operating a renewable energy facility.
v. Batteries Cost—for example, the cost to procure lithium ion or other batteries for a renewable energy facility.
vi. Battery Technology—for example, the type of batteries being used in a renewable energy facility, such as lithium ion.
vii. BOS Cost—for example, balance of system costs may include all components of a solar power plant other than the photovoltaic panels.
viii. CapEx—for example, the total cost in dollars of the capital expenses required to develop and build a new renewable energy facility.
ix. Cost of Interconnection—for example, a cost of connecting a proposed renewable energy power plant to an existing electricity grid.
x. Debt Sizing—for example the amount of term debt or construction debt to borrow to operate or build a renewable energy facility.
xi. Details of ‘Renewable Energy Credit’ (“REC”) and other economic incentive attributes—for example, the nature and value of governmental payments or rebates for developing a proposed renewable energy plant.
xii. EPC Cost—for example, the cost in dollars for engineering, procurement, and construction of a proposed renewable energy plant.
xiii. Expected Generation Degradation Rate(s)—for example, a rate at which output and maximum potential output will drop for a proposed renewable energy plant due to use, wear and tear.
xiv. Expected Profit Margin on COD Sale—for example, the expected profit in dollars or dollars per watt or dollars per MW expected to be realized by a developer upon a project sale at or near the commercial operation date.
xv. Expected Profit Margin on NTP Sale—for example, the expected profit in dollars or dollars per watt or dollars per MW expected to be realized by a developer upon a project sale at or near the notice to proceed date.
xvi. Federal Tax Rate—for example, the tax rate on a project sale and or profit accrued to the operating renewable energy facility.
xvii. Generation Profiles—for example, expected generation forecasts based on technology and possible weather variations including the presence, nature, and variability of potential output patterns from a proposed renewable energy plant.
xviii. Insurance Costs—for example, the expected annual cost of insurance for insuring a proposed renewable energy plant.
xix. Interconnection Voltage—for example, substation voltage at the point of interconnection to an electricity grid.
xx. Interconnection Costs
xxi. Inverter Technology—for example, type(s) of photovoltaic inverter technology or equipment used at a proposed solar power plant
xxii. Inverter Costs—for example, the cost in dollars to purchase equipment for a proposed renewable energy plant.
xxiii. IRR During Contracted Period
xxiv. ITC Assumed—for example, tax credits assumed by solar power plants or battery facilities.
xxv. Key Timeline Milestones—for example, how soon construction on a proposed renewable energy power plant will start, when the construction will end, when power will first be output from the renewable energy power plant.
xxvi. Land Costs—for example, the expected cost, in dollars to purchase, rent, or lease land necessary for a proposed renewable energy plant.
xxvii. Leverage Level—for example, how much construction or term debt the project may take on.
xxviii. Levered After-Tax IRR—for example, the rate of return as a percentage including debt and taxes in the calculation.
xxix. Location Information—for example, the geographic and political jurisdiction where a renewable energy power plant will be located including state, county (if any) and locality.
xxx. Management Target IRR During Contracted Period—for example, the target rate of return as a percentage during the life of an ‘anchor’ renewable energy contract.
xxxi. Management Target Levered IRR—for example, the target rate of return as a percentage over the life of a renewable energy power plant, including debt in the calculation.
xxxii. Management Target Unlevered IRR—for example, the target rate of return as a percentage over the life of a renewable energy power plant, not including debt in the calculation.
xxxiii. Market—for example the power market in which the proposed renewable energy power plant will be sited and will sell its output.
xxxiv. Module Technology—for example, type(s) of photovoltaic technology or equipment used to produce energy at a proposed solar power plant
xxxv. Modules Cost—for example, the cost in dollars of procuring the photovoltaic modules for a solar power plant.
xxxvi. Multiple on Invested Capital—for example, a multiple in the format “#x” representing the return on invested development capital into a development renewable energy project.
xxxvii. Operations and Maintenance Costs—for example the ongoing costs to safely operate a renewable energy power plant.
xxxviii. Other Technology—for example, type(s) of technology or equipment used to produce energy at a renewable energy power plant
xxxix. Other Financial Commitments—for example, a catch-all category for costs required to develop a proposed renewable energy plant that are otherwise not reflected in other inputs.
xl. Point of interconnection—for example, the location where a proposed renewable energy power plant will connect to an existing electricity grid.
xli. PTC Assumed—for example, tax credits assumed by wind power plants
xlii. Size/capacity—for example, an amount of output expected from a proposed renewable energy plant, and the maximum potential output from a proposed renewable energy plant.
xliii. Taxes—for example, the expected property, state, and/or federal taxes for a proposed renewable energy plant.
xliv. Turbine Technology—for example, type(s) of turbine technology or equipment used to produce energy at a proposed wind power plant
xlv. Turbines Cost—for example, the cost in dollars of procuring the turbines for a wind power plant.
xlvi. Unlevered After-Tax IRR—for example, a percentage reflecting the rate of return of investing in a renewable energy power plant considering taxes but without consideration debt in the calculation.
xlvii. Upfront Land Purchase Cost—for example, a cost in dollars to purchase land to build and operate a renewable energy power plant.
xlviii. Useful Life—for example, the expected life of a proposed renewable energy plant and its underlying technology (e.g., turbines, panels, inverters).
xlix. Weather for a location corresponding to the location information—for example, likely extremities of temperatures during the year, presence, and consistency of sun versus clouds during the year, presence, and consistency of wind during the year.

b. Project certifications
i. Site/real estate control—for example, prospects for obtaining and/or maintaining controls of the proposed site for the proposed renewable energy plant.
ii. Zoning rights
iii. Engineering, procurement, and construction plans
iv. Geotechnical studies
v. Cultural studies
vi. Interconnection status
vii. Interconnection risks
viii. Power flow studies
ix. Transmission studies
x. Congestion studies
xi. Basis risk forecasts/studies
xii. Tax abatement information
xiii. Insurance requirements and costs
xiv. Development spend
xv. Other revenue agreements (if applicable)
xvi. Equipment weatherization status
xvii. Mineral rights status
xviii. Other permits

c. Proposal details
i. REC swap details, if applicable
ii. Is the proposal ‘indicative’ and subject to management approval?
iii. Is the proposal ‘firm’ and approved by management?
iv. Conditions precedent to closing
v. Contracting preferences

d. Proposer details and information
i. Business model
ii. Development experience
iii. Ability to collateralize revenue hedges such as PPAs
iv. Legal support
v. Size of balance sheet

e. Renewable energy contract terms and details
i. Basis Risk Mitigation
ii. Capacity (MW-AC)
iii. Capacity Left Unhedged
iv. Construction LDs
v. Contract Duration
vi. Contract Type
vii. Credit Support Details
viii. Deemed Delivered Energy
ix. Delivery Schedule
x. Economic Curtailment
xi. End Date
xii. Expected Commercial Operation or Start Date (COD)
xiii. Fee Amount
xiv. Fee Structure
xv. Guaranteed Commercial Operation Date (COD)
xvi. Key Milestones/Timeline
xvii. Limit of Liability
xviii. Missed Milestone Penalties
xix. Offtaker Credit Rating
xx. Offtaker Credit Support Type
xxi. Offtaker Post-COD Credit Support Amount
xxii. Offtaker Pre-COD Credit Support Amount
xxiii. Payment Terms
xxiv. Permitted Transferees
xxv. Power Delivery Point
xxvi. Pre-Set Offer Curve
xxvii. Price
xxviii. Price Escalator
xxix. Production Guarantee
xxx. Production Guarantee LDs
xxxi. Production Guarantee Mechanics
xxxii. Products
xxxiii. Quantity of MW-AC per Hour
xxxiv. Quantity of MWh Per Year
xxxv. Real-Time or Day-Ahead
xxxvi. REC Type
xxxvii. Seller Credit Support Type
xxxviii. Seller NTP to COD Credit Support Amount
xxxix. Seller Parent Credit Rating
xl. Seller Post-COD Credit Support Amount
xli. Seller Post-COD Liability
xlii. Seller Pre-COD Liability
xliii. Seller Pre-NTP Credit Support Amount
xliv. Settlement Period
xlv. Settlement Type
xlvi. Start Date
xlvii. Structure
xlviii. Test Energy
xlix. Total MWh
l. Upside Share

The examples above are not exhaustive. Additionally, in some cases the examples above may include subject matter that at least partly overlaps with one another.

At S330, a range of potential scenarios are simulated for each proposal received at S320. One or more potential scenarios may be simulated based on, for example, proposal inputs above such as project details/information relating to a renewable energy plant as well as terms from the proposal(s) outlining the sale of renewable energy from the renewable energy plant (see renewable energy contract terms and details above). The simulations at S330 are detailed more in FIG. 3B, and may include quantifying and/or digitizing variables for one or more terms and then comparing the quantified and/or digitized variables with thresholds to determine if a quantified and/or digitized variable is below a threshold (when the quantified and/or digitized variable is in a range) or to determine if a quantified and/or digitized variable is a negative binary result (when the quantified and/or digitized variable is a binary). Simulations and results (scores) for simulations may vary in many ways. Examples of possible score types for example simulations are described as follows:
f. Net cash flows→range (e.g., P1 to P99 or low, medium, high)
g. Construction and term debt leverage levels→range
h. Revenue to the project→range
i. Basis risk, if applicable→range
j. Shape risk, if applicable→range
k. Discounted net cash flows→range
l Operations and maintenance costs→range
m. Engineering and generation/performance→range
n. Expected economic performance metrics→ranges
o. Exposure to power price volatility→ranges
p. Return profiles for various investor types→ranges with minimum threshold
q. Seller's return during the contracted period→ranges with minimum threshold
r. Expected profit and loss (per unit of electricity)→ranges
s. Credit support/hedge collateralization levels→usually binary
t. Debt service coverage ratio→ranges with minimum threshold
u. Buyer credit worthiness/status→ranges with minimum threshold
v. Revenue hedge risk allocation→ranges with minimum threshold
w. Generation/performance and degradation→ranges with minimum threshold
x. Production guarantees and associated damages, if applicable→typically binary

Examples of inputs for simulations are described as follows:
y. Proposal inputs
z. Lender requirements
aa. Equity investor requirements
bb. Weather
cc. Revenue contract(s) terms and conditions
dd. Credit support type and amount
ee. Damages calculations

Examples of stakeholders to which simulations may be applied are described as follows:
ff. Seller (e.g., project and/or operating power plant)
gg. Buyer (e.g., energy ‘consumer’)
hh. Project lender(s)
ii. Project equity investors (e.g., cash equity and tax equity)
jj. Credit support providers, when applicable

In an example, a simulation uses one or more binary scores for a simulation. If any of the binary scores is negative, the composite reflects an unfulfillable proposal.

In another example, a simulation uses one or more ranges of scores as inputs to one or more equations for a simulation. The output of the equation(s) reflects each of the ranges of scores weighted by a corresponding weight for each proposal input and/or term. The weights for proposal inputs and/or terms may be identified by applying artificial intelligence derived from previous reverse auctions. The winner of a reverse auction may be identified based on weighting the proposal inputs and/or terms by overweighting proposal inputs and/or terms deemed most important to identifying any proposal as likely to be unfulfillable. A method performed by a reverse auction system and/or auction system may include identifying at least one proposal input and/or term deemed to be most important relative to other proposal inputs and/or terms in identifying any proposal as likely to be unfulfillable, and identifying at least one proposal input and/or term deemed to be of higher importance relative to the other proposal inputs and/or terms in categorizing each proposal that is likely to be unfulfillable.

In another example, a simulation uses a mixture of binary scores and ranges for a simulation. If any of the binary scores is negative, the composite reflects an unfulfillable proposal, but if all binary scores are positive, the ranges of scores used as inputs for one or more equations will provide an output reflecting both the binary scores and the ranges of scores.

At S340, the method of FIG. 3A includes generating a risk profile of risks of each proposal including risks specific to one or more requirements that may not be performable.

At S350, each proposal that is likely to be unfulfillable is categorized in one category and each proposal that is likely to be fulfillable is categorized in another category. More than two categories may be possible. For example, a first category may be that a proposer cannot fulfill proposal obligations/requirements (i.e., minimum thresholds and binary requirements are not met). A second category may be that a proposer can fulfill proposal obligations/requirements (i.e., minimum thresholds and binary requirements met, and simulations are on medium to high end of range). A third category may be for likely unfulfillable proposals when a proposer may be able to fulfill proposal obligations/requirements (i.e., minimum thresholds and binary requirements met, but simulations are on low end of ranges).

At S361, unfulfillable proposals are identified. At S362, likely unfulfillable proposals are identified. At S363, fulfillable proposals are identified.

At S371, specific deficiencies of unfulfillable proposals are identified. The specific deficiencies may require remedy for the corresponding proposal to be fulfillable, and the proposer may be notified of the specific deficiencies.

As set forth above, proposals may be ranked on a variety of bases, may be binned with similar proposals for a project, and may be analyzed and ranked to identify the best proposals. Proposals may be subject to multiple simulations, including a base case proposal for the most likely requirements for an accepted proposal, and including alternative simulations with variations to the base case requirements. For example, one or more simulations may be run, and proposals may be placed into bins with similar proposals based on each type of simulation to see if results change based on minor variations between simulations. From the simulations, a base case may be used to compare different proposals with the best results using the primary criteria in the base case simulation, and one or more alternative(s) to the base case may be used to compare different proposals with the best results in the alternative simulations.

At S372, specific deficiencies of likely unfulfillable proposals are identified. The specific deficiencies may be for individual proposal inputs and/or terms or sets of proposal inputs and/or terms with quantified and/or digitized variables at the low end of ranges, for example, and may be identified as the proposal inputs and/or terms most responsible for making the corresponding proposal rank low among proposals. When the corresponding proposals are not identified as winners of the reverse auction, the proposers may be notified of the specific deficiencies. In some embodiments, the proposers may be notified in an interactive process before the reverse auction concludes, so that the proposers may attempt to remedy their proposals.

At S380, an optimum proposal is identified as a winner from proposals categorized as likely to be fulfillable.

The method of FIG. 3A may be performed partly or fully by the server 211 or the data center 210 executing instructions. The instructions may be executed responsive to receiving the terms at S310 and to receiving the proposals at S320. Additionally, the method of FIG. 3A may include applying artificial intelligence developed based on previous reverse auctions, and the results of the reverse auction in FIG. 3A may be used as the basis for further development of the artificial intelligence. The artificial intelligence may identify the most important proposal inputs and/or terms and the boundaries between viable and unviable proposals based on analyzing the data sets of the previous reverse auctions.

FIG. 3B illustrates a method for simulating in auction result adjustment with threshold-based stakeholder simulations, in accordance with a representative embodiment.

In FIG. 3B, a simulation may involve quantifying and/or digitizing one or more proposal inputs and/or terms of a proposal, and then comparing the quantified and/or digitized proposal inputs and/or term(s) with thresholds when the quantified and/or digitized proposal inputs and/or terms term(s) are in a range, or otherwise simply determining a binary outcome. The simulation may involve iterative quantifications and/or digitizations and comparisons or determinations, for each proposal input and or term or set of proposal inputs and/or terms that can be quantified and/or digitized. Additionally, the simulation detailed in FIG. 3B is shown for a first stakeholder, but simulations may be performed for multiple stakeholders in a reverse auction or auction, each separately in the manner shown for the first stakeholder in FIG. 3B.

At S331, after the simulations start at S330, a simulation with binary outcomes is performed, and at S332 a determination is made whether the simulation at S331 produces an adverse result. The simulations at S331 and S332 are for specific proposal inputs and/or terms or sets of proposal inputs and/or terms that can affect the overall likelihood of a proposal being unfulfillable, and may be performed iteratively for different specific proposal inputs and/or terms or sets of proposal inputs and/or terms. Assuming an adverse result among the potential binary outcomes is a “0”, the adverse result at S332 may be determined when the “0” score is assigned in the simulation at S331. If the adverse result is not determined (S332=No), the simulation at S331 is not likely to result in an overall categorization for the proposal as being likely to be unfulfillable, and this is shown at S333 as a determination result. If the adverse result is determined (S332=Yes), the simulation at S331 is likely to result in an overall categorization for the proposal as being likely to be unfulfillable, and this is shown at S334 as a determination result.

At S336, after the simulations start at S330, a simulation with a range of outcomes is performed, and at S337, a determination is made whether the simulation at S336 produces a result below a minimum acceptable level. The simulations at S336 and S337 are again for specific proposal inputs and/or terms or sets of proposal inputs and/or terms that can affect the overall likelihood of a proposal being unfulfillable, and may be performed iteratively for different specific proposal inputs and/or terms or sets of proposal inputs and/or terms. If the result determined at S337 is below the minimum acceptable level (S337=Yes), the simulation at S336 is likely to result in an overall categorization for the proposal as being likely to be unfulfillable, and this is shown at S334 as a determination result. If the result determined at S337 is not below the minimum acceptable level (S337=No), the simulation at S336 is not likely to result in an overall categorization for the proposal as being likely to be unfulfillable, and this is shown at S333 as a determination result.

After S333 or S334 in each iteration, a determination is made at S338 whether the simulation is the last simulation. If the simulation is not the last simulation (S338=No), the process iteratively returns to S331 and/or S336 for the next specific proposal input and/or term or set of proposal inputs and/or terms. If the simulation is the last simulation (S338=Yes), a final step in FIG. 3B is to identify deficiencies requiring remedy to make a proposal fulfillable at S339. The identification at S339 is only performed if there are any deficiencies to identify.

In FIG. 3B, two categories of “Likely Unfulfillable” and “Not Likely Unfulfillable” are shown. However, embodiments based on FIG. 3B are not limited to two categories, and instead other categories and divisions may be provided. For example, three categories may be provided including “Fulfillable”, “Likely Fulfillable” and “Not Likely Fulfillable”, with each category corresponding to different risk ranges for the simulation(s) being performed. Additionally, the number and type of categories may vary based on which type of stakeholder simulation is being performed, and/or based on other criteria such as the number of proposals submitted in response to a request for proposals.

In FIG. 3B, the process detailed from S330 to S339 is for a first stakeholder such as a lender or a proposer in a reverse auction. However, the same or similar processes may be performed for other stakeholders in FIG. 3B as long as sufficient information is made available. The entire simulation process from S330 to S339 may be performed for multiple different entities, including buyers, sellers, credit support providers, equity investors, lenders and more using available information, and this may result in identifying proposals that are not fulfillable or are not likely to be fulfillable for reverse auctions and auctions.

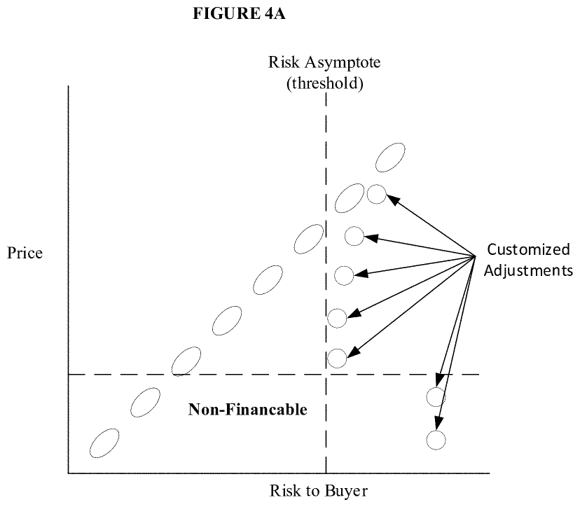

FIG. 4A illustrates another visualization of theoretical results versus actual/predictable results in a reverse auction, in accordance with a representative embodiment.

In FIG. 4A, price is shown on the Y axis and risk to buyer is shown on the X axis. Ovals corresponding to proposals are shown by ovals, and customized adjustments to the proposals are shown by circles. A cutoff shown as a broken horizontal line denotes a primary threshold between proposals deemed likely to be financed and proposals deemed likely to not be financed. The primary threshold denotes a price below which proposals are unlikely to be fulfillable.

In FIG. 4A, the customized adjustments show that as the price decreases, the actual risk to the buyer does not decrease as is theoretically indicated. Rather, the actual risk to the buyer approaches a risk asymptote that serves as a secondary threshold. Below the primary threshold, the actual risk increases to a maximum risk level reflecting that the corresponding proposals will not be fulfillable.

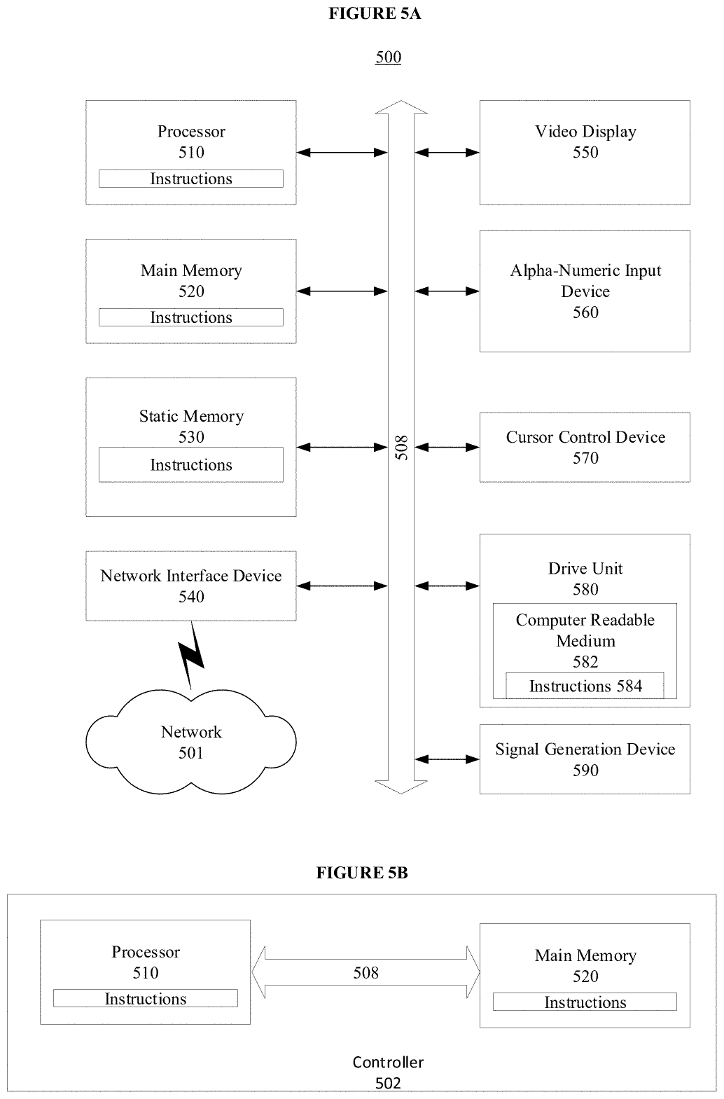

FIG. 5A illustrates a computer system, on which a method for auction result adjustment with threshold-based stakeholder simulations is implemented, in accordance with another representative embodiment.

The computer system 500 of FIG. 5 shows a complete set of components for a communications device or a computer device. However, a “controller” as described herein may be implemented with less than the set of components of FIG. 5, such as by a memory and processor combination. The computer system 500 may include some or all elements of one or more component apparatuses in a system for auction result adjustment with threshold-based stakeholder simulations herein, although any such apparatus may not necessarily include one or more of the elements described for the computer system 500 and may include other elements not described.

Referring to FIG. 5, the computer system 500 includes a set of software instructions that can be executed to cause the computer system 500 to perform any of the methods or computer-based functions disclosed herein. The computer system 500 may operate as a standalone device or may be connected, for example, using a network 501, to other computer systems or peripheral devices. In embodiments, a computer system 500 performs logical processing based on digital signals received via an analog-to-digital converter. The computer system 500 is used to implement an auction system and/or reverse auction system described herein.

In a networked deployment, the computer system 500 operates in the capacity of a server or as a client user computer in a server-client user network environment, or as a peer computer system in a peer-to-peer (or distributed) network environment. The computer system 500 can also be implemented as or incorporated into various devices, such as the server 211 in FIG. 2A, a stationary computer, a mobile computer, a personal computer (PC), a laptop computer, a tablet computer, or any other machine capable of executing a set of software instructions (sequential or otherwise) that specify actions to be taken by that machine. The computer system 500 can be incorporated as or in a device that in turn is in an integrated system that includes additional devices. In an embodiment, the computer system 500 can be implemented using electronic devices that provide voice, video, or data communication. Further, while the computer system 500 is illustrated in the singular, the term “system” shall also be taken to include any collection of systems or sub-systems that individually or jointly execute a set, or multiple sets, of software instructions to perform one or more computer functions.

As illustrated in FIG. 5A, the computer system 500 includes a processor 510. The processor 510 executes instructions to implement some or all aspects of methods and processes described herein. The processor 510 is tangible and non-transitory. As used herein, the term “non-transitory” is to be interpreted not as an eternal characteristic of a state, but as a characteristic of a state that will last for a period. The term “non-transitory” specifically disavows fleeting characteristics such as characteristics of a carrier wave or signal or other forms that exist only transitorily in any place at any time. The processor 510 is an article of manufacture and/or a machine component. The processor 510 is configured to execute software instructions to perform functions as described in the various embodiments herein. The processor 510 may be a general-purpose processor or may be part of an application specific integrated circuit (ASIC). The processor 510 may also be a microprocessor, a microcomputer, a processor chip, a controller, a microcontroller, a digital signal processor (DSP), a state machine, or a programmable logic device. The processor 510 may also be a logical circuit, including a programmable gate array (PGA), such as a field programmable gate array (FPGA), or another type of circuit that includes discrete gate and/or transistor logic. The processor 510 may be a central processing unit (CPU), a graphics processing unit (GPU), or both. Additionally, any processor described herein may include multiple processors, parallel processors, or both. Multiple processors may be included in, or coupled to, a single device or multiple devices.

The term “processor” as used herein encompasses an electronic component able to execute a program or machine executable instruction. References to a computing device comprising “a processor” should be interpreted to include more than one processor or processing core, as in a multi-core processor. A processor may also refer to a collection of processors within a single computer system or distributed among multiple computer systems. The term computing device should also be interpreted to include a collection or network of computing devices each including a processor or processors. Programs have software instructions performed by one or multiple processors that may be within the same computing device or which may be distributed across multiple computing devices.

The computer system 500 further includes a main memory 520 and a static memory 530, where memories in the computer system 500 communicate with each other and the processor 510 via a bus 508. Either or both of the main memory 520 and the static memory 530 may be considered representative examples of the memory 1222 of the controller 122 in FIG. 1B, and store instructions used to implement some or all aspects of methods and processes described herein. Memories described herein are tangible storage mediums for storing data and executable software instructions and are non-transitory during the time software instructions are stored therein. As used herein, the term “non-transitory” is to be interpreted not as an eternal characteristic of a state, but as a characteristic of a state that will last for a period. The term “non-transitory” specifically disavows fleeting characteristics such as characteristics of a carrier wave or signal or other forms that exist only transitorily in any place at any time. The main memory 520 and the static memory 530 are articles of manufacture and/or machine components. The main memory 520 and the static memory 530 are computer-readable mediums from which data and executable software instructions can be read by a computer (e.g., the processor 510). Each of the main memory 520 and the static memory 530 may be implemented as one or more of random access memory (RAM), read only memory (ROM), flash memory, electrically programmable read only memory (EPROM), electrically erasable programmable read-only memory (EEPROM), registers, a hard disk, a removable disk, tape, compact disk read only memory (CD-ROM), digital versatile disk (DVD), floppy disk, blu-ray disk, or any other form of storage medium known in the art. The memories may be volatile or non-volatile, secure and/or encrypted, unsecure and/or unencrypted.

“Memory” is an example of a computer-readable storage medium. Computer memory is any memory which is directly accessible to a processor. Examples of computer memory include, but are not limited to RAM memory, registers, and register files. References to “computer memory” or “memory” should be interpreted as possibly being multiple memories. The memory may for instance be multiple memories within the same computer system. The memory may also be multiple memories distributed amongst multiple computer systems or computing devices.

As shown, the computer system 500 further includes a video display unit 550, such as a liquid crystal display (LCD), an organic light emitting diode (OLED), a flat panel display, a solid-state display, or a cathode ray tube (CRT), for example. Additionally, the computer system 500 includes an input device 560, such as a keyboard/virtual keyboard or touch-sensitive input screen or speech input with speech recognition, and a cursor control device 570, such as a mouse or touch-sensitive input screen or pad. The computer system 500 also optionally includes a disk drive unit 580, a signal generation device 590, such as a speaker or remote control, and/or a network interface device 540.

In an embodiment, as depicted in FIG. 5, the disk drive unit 580 includes a computer-readable medium 582 in which one or more sets of software instructions 584 (software) are embedded. The sets of software instructions 584 are read from the computer-readable medium 582 to be executed by the processor 510. Further, the software instructions 584, when executed by the processor 510, perform one or more steps of the methods and processes as described herein. In an embodiment, the software instructions 584 reside all or in part within the main memory 520, the static memory 530 and/or the processor 510 during execution by the computer system 500. Further, the computer-readable medium 582 may include software instructions 584 or receive and execute software instructions 584 responsive to a propagated signal, so that a device connected to a network 501 communicates voice, video, or data over the network 501. The software instructions 584 may be transmitted or received over the network 501 via the network interface device 540.

In an embodiment, dedicated hardware implementations, such as application-specific integrated circuits (ASICs), field programmable gate arrays (FPGAs), programmable logic arrays and other hardware components, are constructed to implement one or more of the methods described herein. One or more embodiments described herein may implement functions using two or more specific interconnected hardware modules or devices with related control and data signals that can be communicated between and through the modules. Accordingly, the present disclosure encompasses software, firmware, and hardware implementations. Nothing in the present application should be interpreted as being implemented or implementable solely with software and not hardware such as a tangible non-transitory processor and/or memory.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing may implement one or more of the methods or functionalities as described herein, and a processor described herein may be used to support a virtual processing environment.

FIG. 5B illustrates a controller for auction result adjustment with threshold-based stakeholder simulations, in accordance with another representative embodiment.

In FIG. 5B, a controller 502 includes a processor 510, a main memory 520 and a bus 508. The controller may store instructions in the main memory 520 and execute the instructions using the processor 510 so as to implement some or all aspects of the methods described herein. For example, the controller 502 may be implemented in the server 211 in FIG. 2A or the data center 210 in FIG. 2B.

Accordingly, auction result adjustment with threshold-based stakeholder simulations enables dynamic identification of one or more proposal(s) unlikely to be fulfillable. Insofar as the provider of the reverse auctions and auctions described herein may implement the methods described herein, the provider may dynamically identify which proposals are unlikely to be fulfillable and adjust results of the reverse auctions and auctions to that winners of the reverse auctions and auctions are parties actually capable of fulfilling their proposals and otherwise providing the best terms to the counterparty from the parties deemed capable of fulfilling their proposals.

As described above, a machine-learning framework may be applied to proposal inputs and/or terms and/or simulation results to determine viability (including relative viability) of proposals for auctions and reverse auctions. The simulations may be run based on volumes of information specific to (relevant to) the particular auctions and reverse auctions, such as details for various aspects of a proposed renewable energy plant.

Although auction result adjustment with threshold-based stakeholder simulations has been described with reference to several exemplary embodiments, it is understood that the words that have been used are words of description and illustration, rather than words of limitation. Changes may be made within the purview of the appended claims, as presently stated, and as amended, without departing from the scope and spirit of auction result adjustment with threshold-based stakeholder simulations in its aspects. Although auction result adjustment with threshold-based stakeholder simulations has been described with reference to particular means, materials and embodiments, auction result adjustment with threshold-based stakeholder simulations is not intended to be limited to the particulars disclosed; rather auction result adjustment with threshold-based stakeholder simulations extends to all functionally equivalent structures, methods, and uses such as are within the scope of the appended claims.

The illustrations of the embodiments described herein are intended to provide a general understanding of the structure of the various embodiments. The illustrations are not intended to serve as a complete description of all of the elements and features of the disclosure described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The preceding description of the disclosed embodiments is provided to enable any person skilled in the art to practice the concepts described in the present disclosure. As such, the above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

I claim:

1. A reverse auction system, comprising:
a memory that stores instructions, and
a processor that executes the instructions, wherein, when executed by the processor, the instructions cause the reverse auction system to:
receive terms for initiating a reverse auction;
receive at least one proposal for the reverse auction;
simulate, for each proposal, a range of potential scenarios of attempts to fulfill the proposal;
categorize, based on simulating the range of potential scenarios for each proposal, each proposal that is likely to be unfulfillable; and
identify each proposal categorized as likely to be unfulfillable.

2. The reverse auction system of claim 1, wherein the instructions further cause the reverse auction system to:
categorize each proposal that is likely to be fulfillable;
identify each proposal categorized as likely to be fulfillable;
rank each proposal categorized as likely to be fulfillable, and
identify a winner of the reverse auction from proposals categorized as likely to be fulfillable.

3. The reverse auction system of claim 2, wherein each proposal that is likely to be unfulfillable is categorized based on a risk that requirements of the proposal cannot be performed.

4. The reverse auction system of claim 3, wherein the instructions further cause the reverse auction system to:
generate, for each proposal, a risk profile that identifies the risk that requirements of the proposal cannot be performed; and
recommend an optimum proposal from proposals categorized as likely to be fulfillable.

5. The reverse auction system of claim 1, wherein the reverse auction is conducted for renewable energy and the proposal is representing an underlying development project.

6. The reverse auction system of claim 3, wherein the risk comprises at least one binary determination of whether a term of the proposal is likely to be fulfillable.

7. The reverse auction system of claim 3, wherein each proposal categorized as likely to be unfulfillable and each proposal categorized as likely to be fulfillable is categorized based on a comparison with a threshold.

8. The reverse auction system of claim 2, wherein the instructions further cause the reverse auction system to:
apply artificial intelligence to identify weights for proposal inputs to simulations run based on each proposal; and
identify the winner based on weighting the proposal inputs and/or terms by overweighting proposal inputs and/or terms deemed most important to identifying any proposal as likely to be unfulfillable.

9. The reverse auction system of claim 8, wherein the at least one proposal and the terms for initiating the reverse auction are received over the internet, and subjected to the artificial intelligence by the reverse auction system to identify the weights for the inputs to simulations.

10. The reverse auction system of claim 2, wherein the instructions further cause the reverse auction system to:
identify at least one proposal input and/or term deemed to be most important relative to other proposal inputs and/or terms in identifying any proposal as likely to be unfulfillable; and
identify at least one proposal input and/or term deemed to be of higher importance relative to the other proposal inputs and/or terms in categorizing each proposal that is likely to be unfulfillable.

11. The reverse auction system of claim 10, wherein the at least one proposal and the terms for initiating the reverse auction are received over the internet, and analyzed by the reverse auction system to identify which proposal input and/or term or proposal inputs and/or terms is most important relative to other proposal inputs and/or terms in identifying any proposal likely to be unfulfillable.

12. An auction system, comprising:
a memory that stores instructions, and
a processor that executes the instructions, wherein, when executed by the processor, the instructions cause the auction system to:
receive terms for initiating an auction;
receive at least one proposal for the auction;
simulate, for each proposal, a range of potential scenarios of attempts to fulfill the proposal;
categorize, based on simulating the range of potential scenarios for each proposal, each proposal that is likely to be unfulfillable; and
identify each proposal categorized as likely to be unfulfillable.

13. The auction system of claim 12, wherein the instructions further cause the auction system to:
categorize each proposal that is likely to be fulfillable;
identify each proposal categorized as likely to be fulfillable, and
identify a winner of the auction from proposals categorized as likely to be fulfillable.

14. The auction system of claim 13, wherein each proposal that is likely to be unfulfillable is categorized based on a risk that requirements of the proposal cannot be performed.

15. The auction system of claim 13, wherein the instructions further cause the auction system to:
apply artificial intelligence to identify weights for proposal inputs to simulations run based on each proposal; and
identify the winner based on weighting the proposal inputs and/or terms by overweighting proposal inputs and/or terms deemed most important to identifying any proposal as likely to be unfulfillable.

16. The auction system of claim 15, wherein the at least one proposal and the terms for initiating the auction are received over the internet, and subjected to the artificial intelligence by the auction system to identify the weights for the inputs to simulations.

17. The auction system of claim 13, wherein the instructions further cause the auction system to:
identify at least one proposal input and/or term deemed to be most important relative to other proposal inputs and/or terms in identifying any proposal as likely to be unfulfillable; and
identify at least one proposal input and/or term deemed to be of higher importance relative to the other proposal inputs and/or terms in categorizing each proposal that is likely to be unfulfillable.

18. The auction system of claim 17, wherein the at least one proposal and the terms for initiating the auction are received over the internet, and analyzed by the auction system to identify which proposal input and/or term or proposal inputs and/or terms is most important relative to other proposal inputs and/or terms in identifying any proposal likely to be unfulfillable.
